(19) United States
(12) Patent Application Publication
(10) Pub. No.: US 2014/0114799 A1
(43) Pub. Date: Apr. 24, 2014

(54) SUGGESTING, MONITORING, AND IMPLEMENTING ADJUSTMENT TO TERM OF SALE FOR SIMILAR ITEMS

(71) Applicants: Srinivasa Pasupulati, Cupertino, CA (US); Ankur Jain, Santa Clara, CA (US)

(72) Inventors: Srinivasa Pasupulati, Cupertino, CA (US); Ankur Jain, Santa Clara, CA (US)

(73) Assignee: eBay Inc., San Jose, CA (US)

(21) Appl. No.: 13/659,268

(22) Filed: Oct. 24, 2012

(51) Int. Cl. G06Q 30/00

(52) U.S. Cl. 705/26.8

(57) ABSTRACT

A system and method of enabling a user to influence a term of sale for similar items is disclosed. An item listing is presented to a user. The item listing comprises an original term of sale, is associated with a seller, and belongs to a cluster of item listings. The user can submit a preferred term of sale for the item listing. The preferred term of sale reflects an adjustment of the original term of sale. Information that incorporates the preferred term of sale is presented to a seller of an item listing that belongs to the cluster of item listings. The seller can adjust the original term of sale for the seller's item listing. The adjusted term of sale can be presented selectively to users who have submitted a preferred term of sale for any item listing belonging to the cluster of item listings.

### TECHNICAL FIELD

The present application relates generally to the technical field of electronic commerce (e-commerce), and, in various embodiments, to systems and methods of suggesting, monitoring, and implementing an adjustment to a term of sale for similar items.

### BACKGROUND

Some e-commerce sites, such as eBay, allow users to monitor item listings using a watch list, thereby making the users aware of changes in pricing or status, such as if an auction item listing is expiring soon. However, users can only monitor specific item listings, so that when a user adds an item listing to his watch list, he is only monitoring that specific item listing having that specific item being sold by that specific seller.

Furthermore, when a user adds an item to a watch list, it typically signifies that the user is not yet ready to make the purchase. The user often wants to wait and take his time in the hopes that the price of the item will come down or that he will soon have sufficient funds to purchase the item.

### BRIEF DESCRIPTION OF THE DRAWINGS

Some embodiments of the present disclosure are illustrated by way of example and not limitation in the figures of the accompanying drawings, in which like reference numbers indicate similar elements and in which:

FIG. 1 is a block diagram depicting a network architecture of a system, according to some embodiments, having a client-server architecture configured for exchanging data over a network.

FIG. 2 is a block diagram depicting various components of a network-based publisher, according to some embodiments.

FIG. 3 is a block diagram depicting an example embodiment of various tables that may be maintained within a database.

FIG. 4 is a snapshot illustrating an example embodiment of an e-commerce page enabling a user to submit a preferred term of sale.

FIG. 5 is a snapshot illustrating an example embodiment of an e-commerce page presenting a seller with information incorporating preferred terms of sale that have been submitted by users.

FIG. 6 is a snapshot illustrating an example embodiment of an e-commerce page presenting a user with an adjusted term of sale.

FIG. 7 is a flowchart illustrating an example embodiment of a method of enabling a user to influence a term of sale for similar items.

FIG. 8 is a flowchart illustrating another example embodiment of a method of enabling a user to influence a term of sale for similar items.

FIG. 9 shows a diagrammatic representation of a machine in the example form of a computer system within which a set of instructions may be executed to cause the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure provides systems and methods that enable a potential buyer to provide a better signal to sellers as to what the potential buyer wants a term of sale (e.g., price) to be for a cluster of similar item listings, and that enable a seller to provide an adjusted term of sale for an item listing in light of signals of desired terms of sale for a cluster of similar item listings. A potential buyer can navigate through an e-commerce site, searching and/or browsing through item listings. Upon viewing an item listing of interest with an original term of sale, such as the price of the item, the potential buyer can indicate to the e-commerce site that he or she is interested in purchasing the item, or a similar item, under a preferred term of sale, such as a desired price. The potential buyer can provide a specific preferred term of sale, such as a specific desired price. The e-commerce site can then inform the seller of that specific item, as well as sellers of similar items, of the potential buyer's interest in purchasing that item, or a similar item, under the preferred term of sale. The e-commerce site can aggregate these types of desired term of sale submissions from multiple potential buyers of the same or similar items and provide the sellers of these items with information regarding these desired terms of sale. Each seller can then decide whether or not to adjust the term of sale for his particular item listing, such as by lowering the price of the item. The potential buyers who have indicated interest in this cluster of items, such as by submitting a desired term of sale, can then be notified of any adjusted term of sale for any of the items in this cluster of items.

In some embodiments, an item listing is presented to a user. The item listing comprises an original term of sale and is associated with a seller. The item listing also belongs to a cluster of item listings. The user is enabled to submit a preferred term of sale for the item listing. The preferred term of sale reflects an adjustment of the original term of sale for the item listing. The preferred term of sale is received from the user. Information that incorporates the preferred term of sale is presented to a seller of an item listing that belongs to the cluster of item listings.

In some embodiments, the seller to which the information that incorporates the preferred term of sale is presented is distinct from the seller of the item listing for which the user submitted the preferred term of sale. In some embodiments, the seller to which the information that incorporates the preferred term of sale is presented is enabled to adjust the original term of sale for the item listing for which the user submitted the preferred term of sale, thereby providing an adjusted term of sale for the item listing. In some embodiments, the adjusted term of sale is presented selectively to users who have submitted a preferred term of sale for any item listing belonging to the cluster of item listings. In some embodiments, the original term of sale is an item sales price. In some embodiments, the original term of sale is a shipping price. In some embodiments, the information that incorporates the preferred term of sale submitted by the user incorporates a plurality of preferred terms of sale, and each preferred term of sale in the plurality of preferred terms of sale has been submitted by a different user.

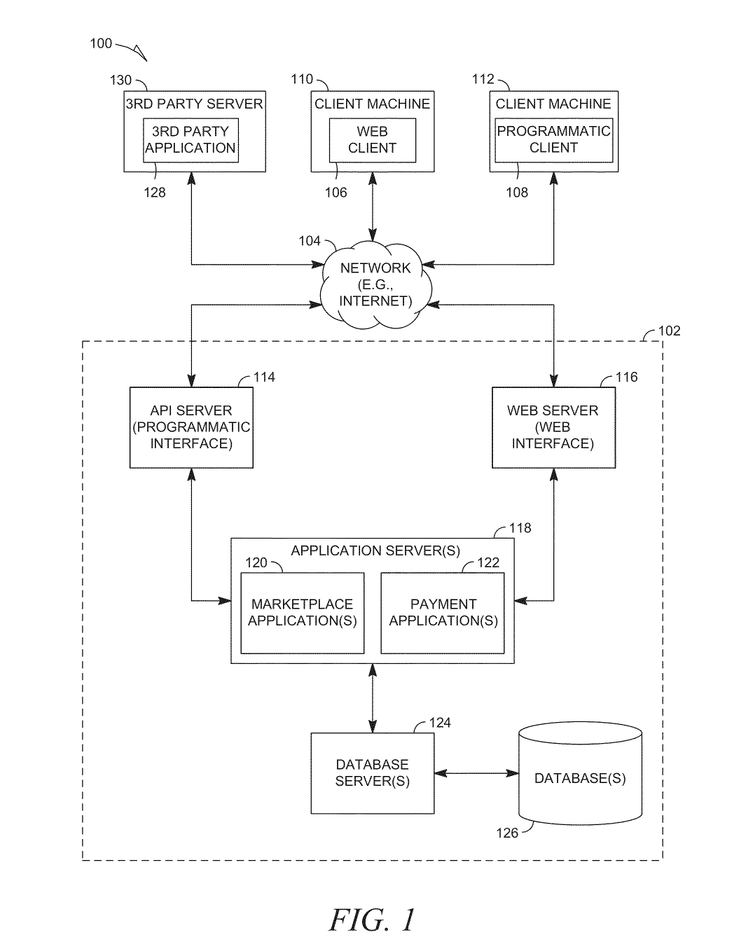

FIG. 1 is a network diagram depicting a client-server system 100, within which one example embodiment may be deployed. A networked system 102, in the example form of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

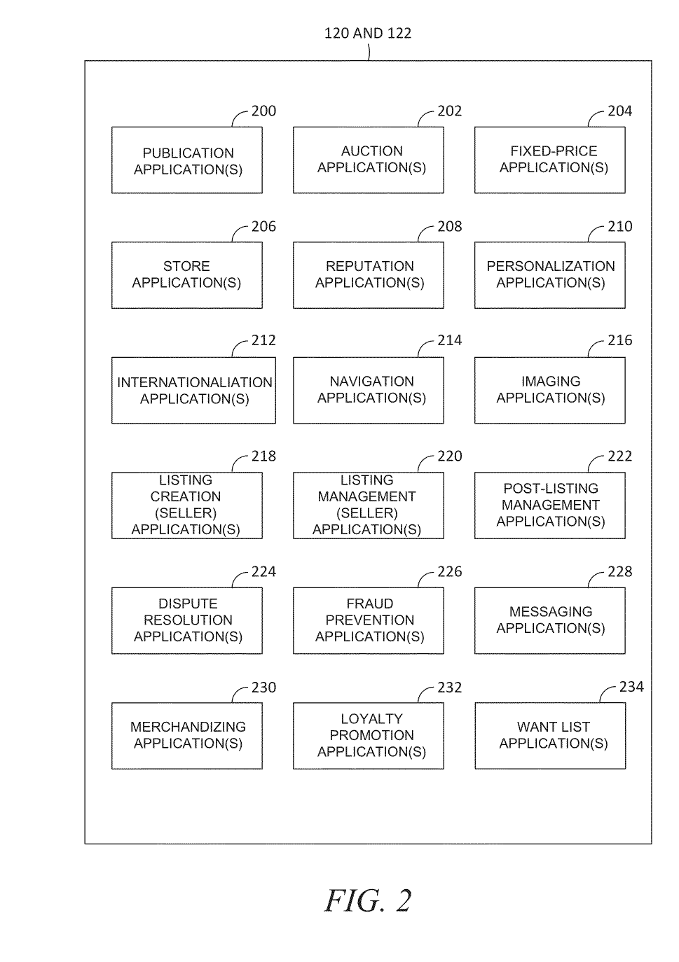

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings, available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

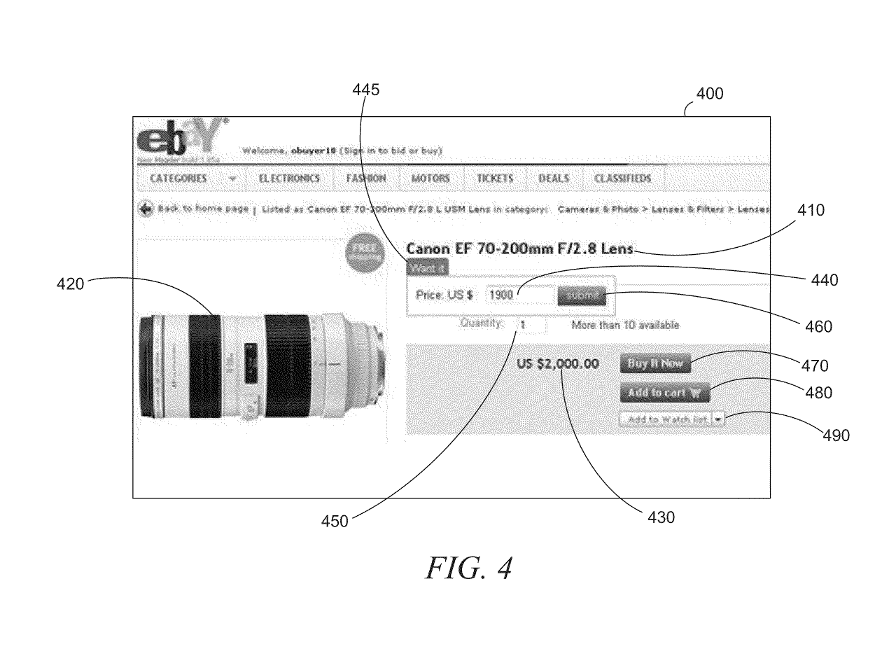

One or more want list applications 234 enable potential buyers to provide better signals to sellers as to what the potential buyers wants a term of sale (e.g., price) to be for a cluster of similar item listings. The one or more want list applications 234 also enable sellers to provide an adjusted term of sale for an item listing in light of signals of desired terms of sale for a cluster of similar item listings. In some embodiments, a want list application 234 is configured to enable a user to submit a preferred term of sale for an item listing. The item listing is associated with a seller and belongs to a cluster of item listings. The preferred term of sale reflects an adjustment of an original term of sale for the item listing. In some embodiments, the want list application 234 is also configured to present information that incorporates the preferred term of sale to a seller of an item listing that belongs to the cluster of item listings. In some embodiments, the want list application 234 is further configured to enable the seller to which the information that incorporates the preferred term of sale is presented to adjust the original term of sale for the item listing for which the user submitted the preferred term of sale, thereby providing an adjusted term of sale. In some embodiments, the want list application 234 is further configured to present the adjusted term of sale selectively to users who have submitted a preferred term of sale for any item listing belonging to the cluster of item listings. Functionality of the one or more want list applications 234 will be discussed in further detail below with respect to FIGS. 4-7.

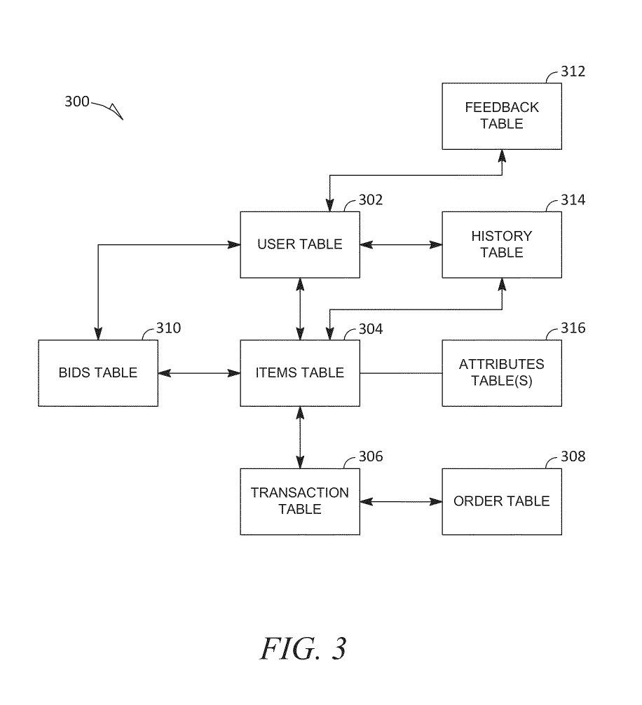

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, each order record being associated with an order. Each order, in turn, may be with respect to one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, the currency attribute identifying the currency of a price for the relevant item as specified in by a seller.

As previously discussed, a want list module (for example, want list application 234 of FIG. 2) can be configured to enable potential buyers to provide better signals to sellers as to what the potential buyers wants a term of sale (e.g., price) to be for a cluster of similar item listings, as well as be configured to enable sellers to provide an adjusted term of sale for an item listing in light of signals of desired terms of sale for a cluster of similar item listings. This want list module can be configured to perform the functions discussed below with respect to FIGS. 4-7.

FIG. 4 is a snapshot illustrating an example embodiment of an e-commerce page 400 that enables a user to provide a better signal to sellers as to what the user wants a term of sale to be for a cluster of similar item listings. The e-commerce page 400 presents an item listing that includes a name or title 410 for the item. In FIG. 4, the title 410 is, for example, the brand and model of a camera lens, “Canon EF 70-200 mm F/2.8 Lens.” The item listing can also include a graphical representation 420 of the item, which is an image of the camera lens in FIG. 4. The item listing also includes an original term of sale 430, such as the price of the item for sale, which is $2,000.00 in FIG. 4. It is contemplated that other terms of sale, such as shipping cost, can also be presented in the item listing. If the user wishes to purchase the item under this original term of sale, the user can make such a selection using one of buttons provided, such as a “Buy It Now” button 470 or an “Add to cart” button 480. The user can also add the item to a Watch List, via an “Add to Watch list” button 490, enabling the user to check the current price of the item simply by accessing the Watch List and to receive notifications, such as e-mails, when the status of the item listing changes or is about to change, such as when the auction for the item is about to end or has already ended.

Sometimes, the user is interested in the item, but is not comfortable with the original term of sale. For example, the user might not be willing to pay the original sales price as specified by the original term of sale 430. The e-commerce page 400 enables the user to indicate a preferred term of sale for which he or she would be willing to purchase the item. In FIG. 4, the e-commerce page 400 provides a tab 445 labeled “Want it” and an accompanying field 440 where the user can enter his or her preferred term of sale, for example, a preferred item sales price of $1,900 in FIG. 4. In some embodiments, limits can be placed on the degree to which the preferred term of sale can differ from the original term of sale. For example, there can be a limit on how much of a reduction in sales price a user can submit for the item listing. The user can also indicate the quantity of the item that he or she would like to purchase, such as by using a quantity field 450. The user can submit this information to the e-commerce site, such as by using a submit button 460. It is contemplated that the user can indicate and submit this information in ways other than using fields and buttons. For example, the use of drop-down menus, check-boxes, and other widgets are also within the scope of the present disclosure.

The e-commerce site can store information regarding a user's preferred term of sale submissions in a “Want It” list. This “Want It” list can retain a list of the items for which the user has submitted a preferred term of sale, along with the preferred term of sale submitted by the user. The e-commerce site can also store the cluster identification of any item for which a preferred term of sale was submitted. Cluster ID's are used to group similar items together. A clustering algorithm can be run on item listings to generate clusters of items based on similarities. Information from item listings, such as item titles and descriptions, can be used to derive affinity between item listings. The e-commerce site can leverage the same type of clustering engine that is used by e-commerce sites to make item recommendations.

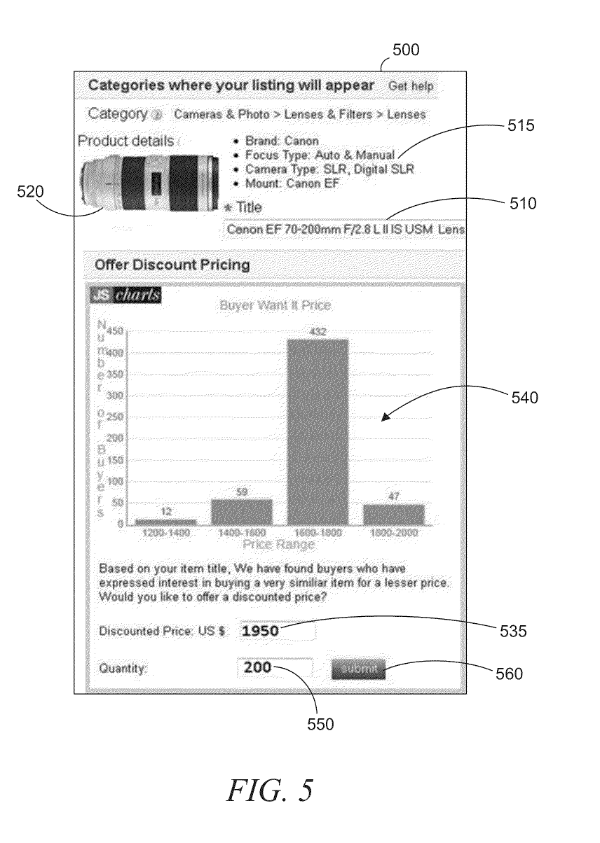

Preferred term of sale submissions for a particular cluster of items can be collected from multiple users. Information regarding these preferred term of sale submissions for the particular cluster ID can then be provided to sellers of items that belong to that particular cluster ID. FIG. 5 is a snapshot illustrating an example embodiment of an e-commerce page 500 presenting a seller of an item with information 540 that incorporates preferred terms of sale that have been submitted by users. The c-commerce page 500 can be a page that the seller logs into, such as eBay's “Sell Your Item” page. The e-commerce page 500 can present a name or title 510 for the item that the seller is selling. In FIG. 5, the title 510 is “Canon EF 70-200 mm F/2.8 L II IS USM Lens.” The e-commerce page 500 can also include a graphical representation 520 of the item, which is an image of a camera lens in FIG. 5. The e-commerce page 500 can also include a description 515 of the item.

In FIG. 5, the information 540 regarding preferred term of sale submissions for a particular cluster ID includes ranges of prices that potential buyers are ready to pay for the item being listed by the seller of an item belonging to that particular cluster ID. This information 540 enables the seller to gauge the interest level in his item and similar items. In FIG. 5, the information 540 is presented in the form of a bar chart displaying the number of potential buyers that submitted a preferred sales price within particular price ranges. It is contemplated that other types of information can be presented, and that the information can be presented in other ways.

This e-commerce page 500 can be presented to all sellers of items that belong to a particular cluster of similar items. It is noted that the item in FIG. 4 (“Canon EF 70-200 mm F/2.8 Lens”) is different from the item in FIG. 5 (“Canon EF 70-200 mm F/2.8 L II IS USM Lens”). However, the preferred term of sale submitted by the user in FIG. 4 can be incorporated into the information provided to the seller in FIG. 5, since the items are similar and share the same cluster ID. The user in FIG. 4 submitted a preferred sales price of $1,900. This preferred sales price is represented in the information 540 presented to the seller in FIG. 5 as one of the 47 preferred sale prices submitted by users that fall within the range of $1,800-$2,000.

In addition to the information regarding preferred term of sale submissions for a particular cluster ID being presented to sellers on an e-commerce page, it is contemplated that other forms of presenting this information to the sellers are also within the scope of the present disclosure. For example, this information can be provided to the sellers in the form of an e-mail, as well as other forms of presentation.

Upon viewing the information 540 regarding preferred term of sale submissions for a particular cluster ID, a seller can offer an adjusted term of sale 535 for his item listing. In FIG. 5, the seller is offering a discounted price of $1,950 for the item. The seller can place certain restrictions on this adjusted term of sale 535. In some embodiments, the seller can place a limit on the quantity 550 of his item that will be available under this adjusted term of sale. In FIG. 5, the seller has limited the number of camera lenses that will be available at the discounted price of $1,950 to only 200 units. Therefore, once 200 units of the camera lenses have been purchased at this discount price, the discount price is no longer available. The seller can also place certain conditions on the adjusted term of sale 535. For example, the seller can make the discount price available only to users with a certain feedback rating, or only to users who are purchasing a minimum quantity of the item. The seller's adjusted term of sale 535 and any restrictions or conditions can be submitted to the e-commerce site, such as by using a “submit” button 560.

Once a seller has submitted an adjusted term of sale for an item, notification of the adjusted term of sale for the item can then be provided to all potential buyers who have expressed interest in that item or similar items (e.g., items having the same cluster ID). In some embodiments, this interest is expressed in the form of a user submitting a preferred term of sale for an item having the same cluster ID as the item for which the adjusted term of sale is submitted. In some embodiments, a user's “Want It” list is used to determine whether he should be notified of the adjusted term of sale. For example, if the user's “Want It” list contains an item having the same cluster ID as the item for which the adjusted term of sale is submitted, then that user will be notified of the adjusted term of sale.

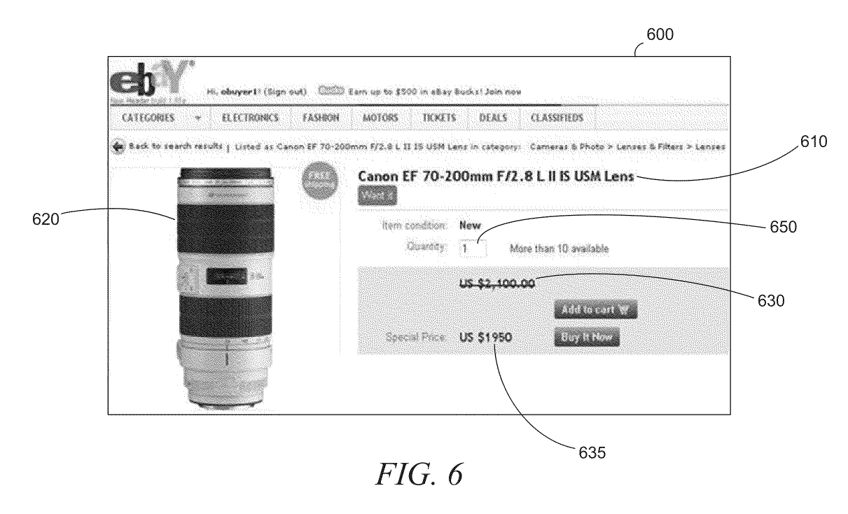

FIG. 6 is a snapshot illustrating an example embodiment of an e-commerce page 600 presenting a user with an adjusted term of sale 635. The e-commerce page 600 presents an item listing that includes a name or title 610 for the item. In FIG. 6, the title 610 is “Canon EF 70-200 mm F/2.8 L II IS USM Lens.” The item listing can also include a graphical representation 620 of the item, which is an image of a camera lens in FIG. 6. The item listing also includes an original term of sale 630, such as the original price of the item for sale, which is $2,100.00 in FIG. 6. As shown in FIG. 6, the original term of sale 630 can be presented as crossed-out, with the adjusted term of sale 635 being presented to the user as a new offer. In FIG. 6, the adjusted term of sale 635 is a special discount price of $1,950. The user can indicate the quantity of the item that he or she would like to purchase, such as by using a quantity field 650.

Looking at the flow from FIG. 4 to FIG. 5 to FIG. 6, it is shown how a user can view an item listing with an original term of sale, indicate an interest in purchasing that item, or a similar item, for a preferred term of sale that is different from the original term of sale, and have that preferred term of sale be incorporated into information presented to a seller of an item that is similar to the item viewed by the user. The seller of the similar item views this information, which incorporates the user's preferred term of sale along with preferred terms of sale submitted by other users for the same item or similar items, and submits an adjusted term of sale that is different from the original term of sale. The user who submitted the preferred term of sale in FIG. 4, along with any other user who has submitted a preferred term of sale for an item belonging to the same cluster as the item of the seller who submitted the adjusted term of sale, is presented with the adjusted term of sale for the seller's item. Users who have not submitted a preferred term of sale for the item or any other item belonging to the same cluster as the item of the seller who submitted the adjusted term of sale are not presented with the adjusted term of sale, but rather the original term of sale. In some embodiments, the adjusted term of sale can be provided to the user via e-mail. In some embodiments, this adjusted term of sale can be provided to the user when the user views the item listing for which the adjusted term of sale was submitted or any other item listing that belongs to the same cluster. In some embodiments, this adjusted term of sale can be provided to the user in the form of a web page containing a list of items in which the user has expressed interest, such as a “Want It” list.

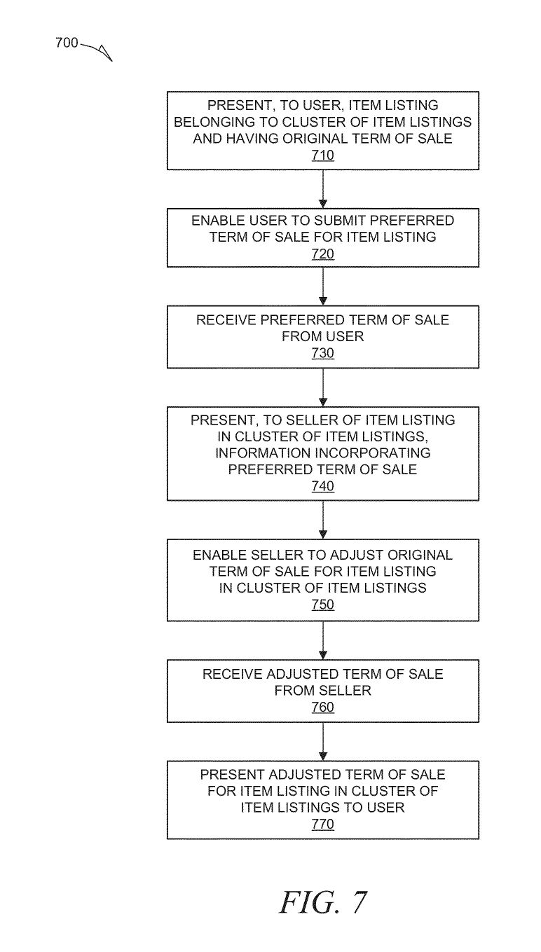

FIG. 7 is a flowchart illustrating an example embodiment of a method 700 of enabling a user to influence a term of sale for similar items. At operation 710, a user is presented with an item listing that has an original term of sale, such as an original sales price. The item listing belongs to a cluster of item listings. The item listings in this cluster have a certain degree of similarity. For example, all of the item listings in the cluster can be for a certain type of camera lens. At operation 720, the user is able to submit a preferred term of sale, such as a reduced sales price, for the item listing. This submission indicates that the user wants to purchase the item in the item listing, or a similar item, under the preferred term of sale. At operation 730, the preferred term of sale is received from the user. This preferred term of sale can be grouped with other preferred terms of sale that have been submitted by users for an item that belongs to the same cluster of items, thereby grouping preferred term of sale submissions for the same and similar item listings. At operation 740, a seller of an item listing that belongs to the cluster of item listings is presented with information that incorporates the preferred term of sale submitted by the user. The information also incorporates other preferred terms of sale that have been submitted for the same or similar item listings that belong to the same cluster. At operation 750, the seller is able to adjust the original term of sale for his item listing by submitting an adjusted term of sale, such as a discounted price, for the item. At operation 760, the adjusted term of sale is received from the seller. At operation 770, the user that submitted the preferred term of sale at operation 720 is presented with the adjusted term of sale for the item listing of the seller that submitted the adjusted term of sale at operation 750. This adjusted term of sale can be presented to all users that have submitted a preferred term of sale for any item that belongs to the same cluster of items as the item for which the seller submitted the adjusted term of sale at operation 750.

In some cases, the cluster of similar items has a very low number of item listings, which is can result in only a small number of sellers being presented with the preferred term of sale and responding with an adjusted term of sale. In order to increase the number of sellers to which a preferred term of sale will be presented and from which an adjusted term of sale will be received, the user's search behavior can be used to find additional relevant sellers. In some embodiments, the user's search behavior is used by the system to find relevant item listings, and the sellers of these item listings are then included in this group of additional sellers. The user's search behavior can include the user's actions on the e-commerce site prior to submitting the preferred term of sale. This behavior can include information regarding the user's trail of activity that led the user to the item listing where he or she submitted the preferred term of sale. This trail of activity information can include the search query entered by the user, a category selected by the user, and any refinements made by the user, such as item brand, buying format (e.g., auction or straight purchase), item condition, seller feedback score, and buyer zip code. This information can be stored in a database by the e-commerce site. The information regarding the user's search behavior can be used to find additional sellers to which the e-commerce site can present the preferred term of sale submitted by the user. For example, a seller might not have an item listing that belongs to the cluster of similar item listings for the particular item listing for which the user submitted the preferred term of sale. However, that seller might be selling an item having a brand name that the user included in his or her search query or that the user selected in his or her trail of activity leading up to submitting a preferred term of sale. As a result, the e-commerce site can determine that this seller is relevant to the user's submitted preferred term of sale and include the seller in the group of sellers that are presented with the preferred term of sale and enabled to submit an adjusted term of sale.

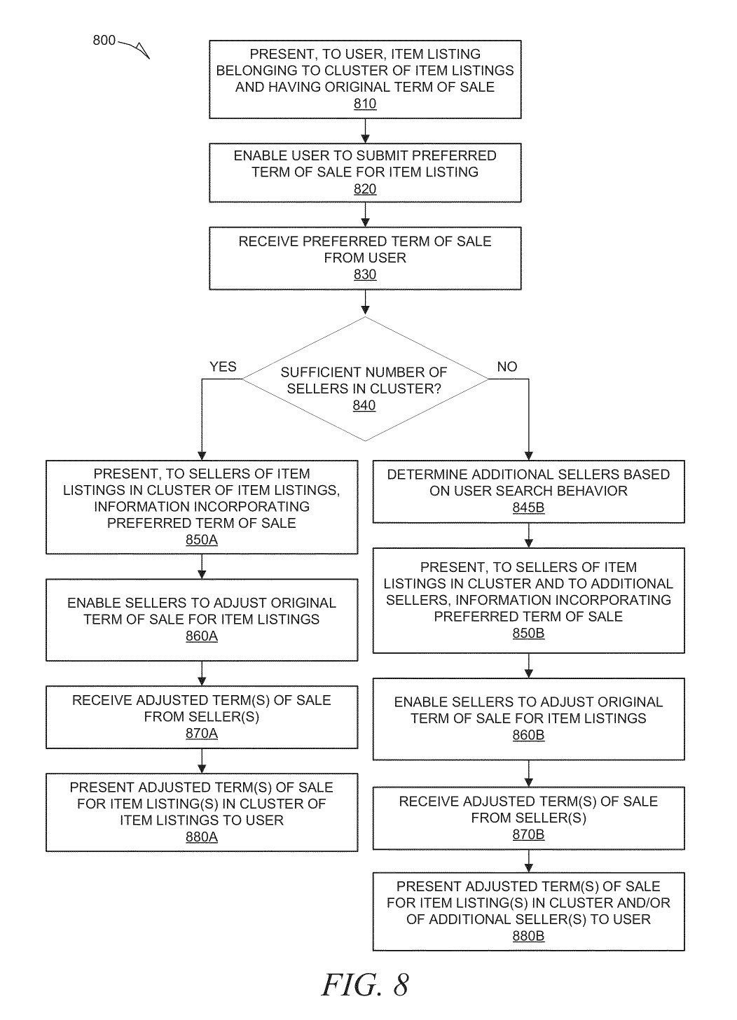

FIG. 8 is a flowchart illustrating another example embodiment of a method 800 of enabling a user to influence a term of sale for similar items. At operation 810, a user is presented with an item listing that has an original term of sale, such as an original sales price. The item listing belongs to a cluster of item listings. The item listings in this cluster have a certain degree of similarity. For example, all of the item listings in the cluster can be for a certain type of camera lens. At operation 820, the user is able to submit a preferred term of sale, such as a reduced sales price, for the item listing. This submission indicates that the user wants to purchase the item in the item listing, or a similar item, under the preferred term of sale. At operation 830, the preferred term of sale is received from the user. This preferred term of sale can be grouped with other preferred terms of sale that have been submitted by users for an item that belongs to the same cluster of items, thereby grouping preferred term of sale submissions for the same and similar item listings. At operation 840, the system determines whether there is a sufficient number of sellers having item listings belonging to the cluster of item listings. This sufficiency determination can be based on a predetermined minimum threshold number of sellers.

If there are a sufficient number of sellers in the cluster, then at operation 850A, sellers of item listings that belong to the cluster are presented with information that incorporates the preferred term of sale submitted by the user. The information also incorporates other preferred terms of sale that have been submitted for the same or similar item listings that belong to the same cluster. At operation 860A, each seller is able to adjust the original term of sale for his or her item listing by submitting an adjusted term of sale, such as a discounted price, for the item. At operation 870A, at least one adjusted term of sale is received from a seller. At operation 880A, the user that submitted the preferred term of sale at operation 820 is presented with the adjusted term of sale for the item listing of the seller that submitted the adjusted term of sale at operation 860A. This adjusted term of sale can be presented to all users that have submitted a preferred term of sale for any item that belongs to the same cluster of items as the item for which the seller submitted the adjusted term of sale at operation 860A. It is contemplated that these users can be presented with all of the adjusted terms of sale submitted by different sellers at operation 860A.

If there are not a sufficient number of sellers in the cluster, then at operation 845B, the system determines additional sellers based on the user's search behavior. As discussed above, the user's search behavior can include the user's actions on the e-commerce site prior to submitting the preferred term of sale. This behavior can include information regarding the user's trail of activity that led the user to the item listing where he or she submitted the preferred term of sale. In some embodiments, this information is used by the system to find relevant item listings, and the sellers of these item listings are then included in this group of additional sellers.

At operation 850B, sellers of item listings that belong to the cluster, as well as the additional sellers determined at operation 845, are presented with information that incorporates the preferred term of sale submitted by the user. The information also incorporates other preferred terms of sale that have been submitted for the same or similar item listings that belong to the same cluster. At operation 860B, each seller is able to adjust the original term of sale for his or her item listing by submitting an adjusted term of sale, such as a discounted price, for the item. At operation 870B, at least one adjusted term of sale is received from a seller. At operation 880B, the user that submitted the preferred term of sale at operation 820 is presented with the adjusted term of sale for the item listing of the seller that submitted the adjusted term of sale at operation 860B. This adjusted term of sale can be presented to all users that have submitted a preferred term of sale for any item that belongs to the same cluster of items as the item for which the seller submitted the adjusted term of sale at operation 860B, as well as to other users that the system has determined to be relevant based on their search behavior. It is contemplated that these users can be presented with all of the adjusted terms of sale submitted by different sellers at operation 860B.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed in various example embodiments.

### Example Machine Architecture and Machine-Readable Medium

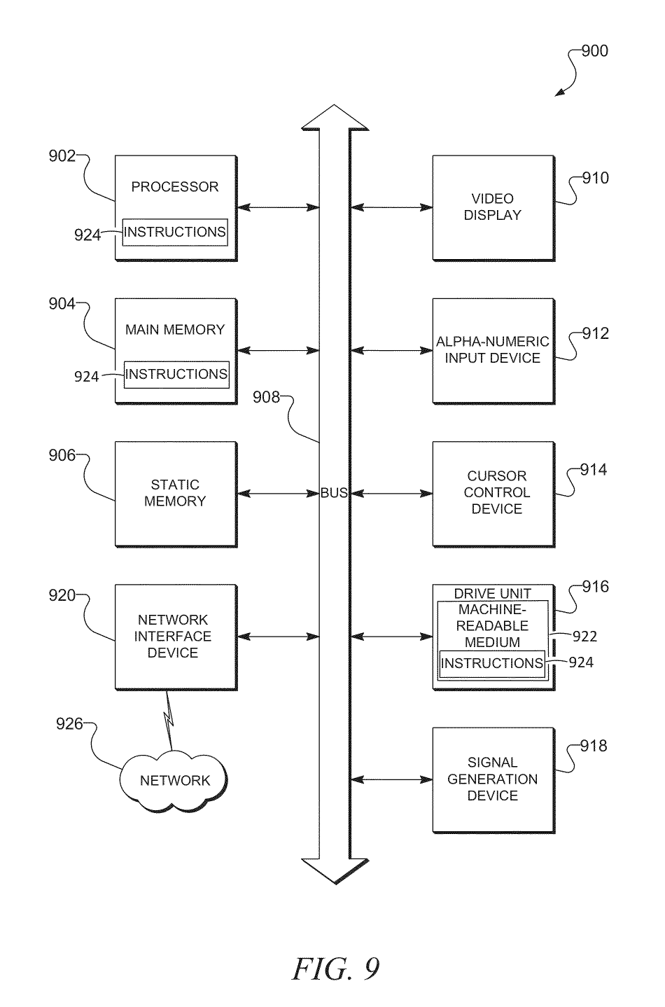

FIG. 9 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. The instructions 924 may also reside, completely or at least partially, within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
one or more processors; and
a want list module, executable by the one or more processors, configured to:
enable a user to submit a preferred term of sale for an item listing, the item listing being associated with a seller and belonging to a cluster of item listings, wherein the preferred term of sale reflects an adjustment of an original term of sale for the item listing; and
present information that incorporates the preferred term of sale to a seller of an item listing that belongs to the cluster of item listings.

2. The system of claim 1, wherein the seller to which the information that incorporates the preferred term of sale is presented is distinct from the seller of the item listing for which the user submitted the preferred term of sale.

3. The system of claim 1, wherein the want list module is further configured to enable the seller to which the information that incorporates the preferred term of sale is presented to adjust the original term of sale for the item listing for which the user submitted the preferred term of sale, thereby providing an adjusted term of sale.

4. The system of claim 3, wherein the want list module is further configured to present the adjusted term of sale selectively to users who have submitted a preferred term of sale for any item listing belonging to the cluster of item listings.

5. The system of claim 1, wherein the original term of sale is an item sales price.

6. The system of claim 1, wherein the original term of sale is a shipping price.

7. The system of claim 1, wherein the information that incorporates the preferred term of sale submitted by the user incorporates a plurality of preferred terms of sale, each preferred term of sale in the plurality of preferred terms of sale having been submitted by a different user.

8. A computer-implemented method comprising:
presenting an item listing to a user, wherein the item listing comprises an original term of sale, is associated with a seller, and belongs to a cluster of item listings;
enabling the user to submit a preferred term of sale for the item listing, wherein the preferred term of sale reflects an adjustment of the original term of sale for the item listing;
receiving the preferred term of sale from the user; and
presenting information that incorporates the preferred term of sale to a seller of an item listing that belongs to the cluster of item listings.

9. The method of claim 8, wherein the seller to which the information that incorporates the preferred term of sale is presented is distinct from the seller of the item listing for which the user submitted the preferred term of sale.

10. The method of claim 8, further comprising enabling the seller to which the information that incorporates the preferred term of sale is presented to adjust the original term of sale for the item listing for which the user submitted the preferred term of sale, thereby providing an adjusted term of sale for the item listing.

11. The method of claim 10, further comprising presenting the adjusted term of sale selectively to users who have submitted a preferred term of sale for any item listing belonging to the cluster of item listings.

12. The method of claim 8, wherein the original term of sale is an item sales price.

13. The method of claim 8, wherein the original term of sale is a shipping price.

14. The method of claim 8, wherein the information that incorporates the preferred term of sale submitted by the user incorporates a plurality of preferred terms of sale, each preferred term of sale in the plurality of preferred terms of sale having been submitted by a different user.

15. A non-transitory machine-readable storage device storing a set of instructions that, when executed by at least one processor, causes the at least one processor to perform operations comprising:
presenting an item listing to a user, wherein the item listing comprises an original term of sale, is associated with a seller, and belongs to a cluster of item listings;
enabling the user to submit a preferred term of sale for the item listing, wherein the preferred term of sale reflects an adjustment of the original term of sale for the item listing;
receiving the preferred term of sale from the user; and
presenting information that incorporates the preferred term of sale to a seller of an item listing that belongs to the cluster of item listings.

16. The device of claim 15, wherein the seller to which the information that incorporates the preferred term of sale is presented is distinct from the seller of the item listing for which the user submitted the preferred term of sale.

17. The device of claim 15, wherein the operations further comprise enabling the seller to which the information that incorporates the preferred term of sale is presented to adjust the original term of sale for the item listing for which the user submitted the preferred term of sale, thereby providing an adjusted term of sale for the item listing.

18. The device of claim 17, wherein the operations further comprise presenting the adjusted term of sale selectively to users who have submitted a preferred term of sale for any item listing belonging to the cluster of item listings.

19. The device of claim 15, wherein the original term of sale is an item sales price.

20. The device of claim 15, wherein the original term of sale is a shipping price.

21. The device of claim 15, wherein the information that incorporates the preferred term of sale submitted by the user incorporates a plurality of preferred terms of sale, each preferred term of sale in the plurality of preferred terms of sale having been submitted by a different user.
